(19) United States
(12) Patent Application Publication
(10) Pub. No.: US 2025/0012957 A1
(43) Pub. Date: Jan. 9, 2025

(54) DOUBLE-SIDED ADHESIVE SHEET, IMAGE DISPLAY DEVICE-CONSTITUTING LAMINATE, AND IMAGE DISPLAY DEVICE

(71) Applicant: MITSUBISHI CHEMICAL CORPORATION, Tokyo (JP)

(72) Inventors: Joji WAKAYAMA, Tokyo (JP); Daiki NOZAWA, Tokyo (JP)

(73) Assignee: MITSUBISHI CHEMICAL CORPORATION, Tokyo (JP)

(21) Appl. No.: 18/896,821

(22) Filed: Sep. 25, 2024

Related U.S. Application Data
(63) Continuation of application No. PCT/JP2023/005155, filed on Feb. 15, 2023.

(30) Foreign Application Priority Data
Mar. 29, 2022 (JP) 2022-053081

(51) Int. Cl. G02B 5/20; C09J 11/06; C09J 133/10; G02B 5/00

(52) U.S. Cl. CPC G02B 5/208; C09J 11/06; C09J 133/10; G02B 5/003

(57) ABSTRACT

The present invention provides a double-sided adhesive sheet having a laminate structure with an intermediate layer (α layer) and a surface layer (β layer), wherein the intermediate layer (α layer) is formed from a resin composition containing a (meth)acrylic polymer, a crosslinking agent, and a photopolymerization initiator; the surface layer (β layer) is formed from an adhesive composition containing a (meth)acrylic polymer, a crosslinking agent, a photopolymerization initiator that can be activated by light having a wavelength of 405 nm or more, and an ultraviolet absorber; and the double-sided adhesive sheet has a stress relaxation rate of 30% or more. The double-sided adhesive sheet has curability, prevents ultraviolet degradation of the adhesive sheet, and has excellent discoloration resistance and step absorbability.

### TECHNICAL FIELD

The present invention relates to a transparent double-sided adhesive sheet that can be suitably used for bonding constituent members of image display devices such as personal computers, mobile terminals (PDAs), game consoles, televisions (TVs), car navigation systems, touch panels, and pen tablets.

### BACKGROUND ART

In recent years, in order to improve the visibility of image display devices, a method has been employed where a gap between an image display panel such as a liquid crystal display (LCD), a plasma display (PDP), or an electroluminescent display (ELD), and a member such as a protective panel or a touch panel disposed on its front side (viewing side) is filled with an adhesive agent to reduce reflections at the air layer interface of incident light and light emitted from the display image.

As a method of filling such a gap between image display device-constituting members with an adhesive agent, a method using an adhesive sheet to fill the gap between the image display device-constituting members is known. As such an adhesive sheet, an adhesive sheet obtained by curing with ultraviolet rays has been proposed, which is useful in that the reaction is easier to control than with thermal curing, and thus easier to handle in the adhesive sheet production process.

On the other hand, in order to prevent ultraviolet degradation of members such as liquid crystal displays, organic EL elements, and polarizing plates, the image display device-constituting members may be required to have an ultraviolet absorption function, but this function has generally been secured by polarizing plate protective films. However, with the thinning of the image display device-constituting members, the polarizing plate protective films also become thinner, making it difficult to achieve a sufficient ultraviolet absorption function. For this reason, it has become necessary to supplement the ultraviolet absorption function with other constitution members such as adhesive layers.

For example, Patent Literature 1 discloses an adhesive sheet having a laminate structure with at least a middle layer and a surface layer, and containing an ultraviolet absorber in the middle layer, in order to prevent degradation of optical members present in the deep layer due to ultraviolet exposure.

Patent Literature 2 discloses a single-layer adhesive sheet containing an ultraviolet absorber.

### CITATION LIST

### Patent Literature

Patent Literature 1: Japanese Patent Laid-Open No. 2017-141442

Patent Literature 2: Japanese Patent Laid-Open No. 2019-194309

### SUMMARY OF THE INVENTION

### Problem to be Solved by the Invention

The adhesive sheet disclosed in the above Patent Literature 1 has a problem in that the surface layer bonded to the outermost member side, such as cover glass, deteriorates due to ultraviolet rays. It also has a problem in that, because the adhesive layer (surface layer on the deep side (β layer)) located deeper in the display than the middle layer containing an ultraviolet absorber cannot undergo secondary curing by ultraviolet rays (also referred to as “main curing”) after the members are bonded, a pressure-sensitive adhesive layer that has been thermally cured in advance is used, resulting in insufficient step absorbability.

The adhesive sheet disclosed in Patent Literature 2, although it can prevent degradation of the adhesive sheet due to ultraviolet exposure, exemplifies only a pressure-sensitive adhesive agent that has been cured with ultraviolet rays in advance, and has a problem in that the step absorbability is insufficient.

Against this background, the object of the present invention is to obtain a double-sided adhesive sheet having curability, preventing ultraviolet degradation of the adhesive sheet, and having excellent discoloration resistance and step absorbability.

### Means for Solving Problem

As a result of extensive studies, the present inventors have discovered and developed a double-sided adhesive sheet having a laminate structure with an intermediate layer (α layer) and a surface layer (β layer), wherein, when the surface layer (β layer) contains a photopolymerization initiator that can be activated by light having a specific wavelength and an ultraviolet absorber, and the double-sided adhesive sheet has a predetermined stress relaxation rate, the double-sided adhesive sheet can be made to have curability, to prevent ultraviolet degradation of the adhesive sheet, and to have excellent discoloration resistance and step absorbability.

Specifically, the present invention includes the following aspects.

[1] A first aspect of the present invention is a double-sided adhesive sheet having a laminate structure with an intermediate layer (α layer) and a surface layer (β layer),
wherein the intermediate layer (α layer) is formed from a resin composition containing a (meth)acrylic polymer, a crosslinking agent, and a photopolymerization initiator;
the surface layer (β layer) is formed from an adhesive composition containing a (meth)acrylic polymer, a crosslinking agent, a photopolymerization initiator that can be activated by light having a wavelength of 405 nm or more, and an ultraviolet absorber; and
the double-sided adhesive sheet has a stress relaxation rate of 30% or more as calculated below.

### <Stress Relaxation Rate>

The stress relaxation rate is obtained by applying 25% strain to an adhesive sheet formed into a thickness in a range of 0.8 to 1.2 mm and punched into a circle shape having a diameter of 8 mm in an environment of 25° C., measuring a stress value (X) after the elapse of 10 seconds and a stress value (Y) after the elapse of 300 seconds, and calculating with the following formula:

Stress relaxation rate (%)={(X−Y)/X}×100

[2] A second aspect of the present invention is the double-sided adhesive sheet according to the first aspect, wherein the stress value (X) is 5,000 to 500,000 Pa and the stress value (Y) is 5,000 to 300,000 Pa.

[3] A third aspect of the present invention is the double-sided adhesive sheet according to the first or second aspect, wherein the photopolymerization initiator contained in the surface layer (β layer) is a cleavage-type photopolymerization initiator.

[4] A fourth aspect of the present invention is the double-sided adhesive sheet according to any one of the first to third aspects, wherein the intermediate layer (α layer) contains a cleavage-type photopolymerization initiator that can be activated by light having a wavelength outside the ultraviolet region.

[5] A fifth aspect of the present invention is the double-sided adhesive sheet according to any one of the first to fourth aspects, wherein the photopolymerization initiator is an acylphosphine oxide-based cleavage-type photopolymerization initiator.

[6] A sixth aspect of the present invention is the double-sided adhesive sheet according to any one of the first to fifth aspects, wherein the double-sided adhesive sheet has a light transmittance at a wavelength of 365 nm or less of 50% or less.

[7] A seventh aspect of the present invention is the double-sided adhesive sheet according to any one of the first to sixth aspects, wherein the intermediate layer (α layer) and the surface layer (β layer) each contain substantially no thermal polymerization initiator.

[8] An eighth aspect of the present invention is the double-sided adhesive sheet according to any one of the first to seventh aspects, wherein the intermediate layer (α layer) has a concentration of the ultraviolet absorber lower than that of the ultraviolet absorber in the surface layer (β layer).

[9] A ninth aspect of the present invention is the double-sided adhesive sheet according to any one of the first to eighth aspects, wherein the adhesive compositions forming the intermediate layer (α layer) and the surface layer (β layer) are different adhesive compositions from each other.

[10] A tenth aspect of the present invention is the double-sided adhesive sheet according to any one of the first to ninth aspects, wherein the (meth)acrylic polymer is a copolymer containing a structural unit derived from a macromonomer.

[11] An eleventh aspect of the present invention is the double-sided adhesive sheet according to any one of the first to tenth aspects, wherein the double-sided adhesive sheet has a gel fraction of 20% to 70%.

[12] A twelfth aspect of the present invention is the double-sided adhesive sheet according to any one of the first to eleventh aspects, wherein the double-sided adhesive sheet is sandwiched and laminated by two image display device-constituting members, and then cured by irradiation with light to bond the two image display device-constituting members.

[13] A thirteenth aspect of the present invention is the double-sided adhesive sheet according to any one of the first to twelfth aspects, wherein the double-sided adhesive sheet has photocurability.

[14] A fourteenth aspect of the present invention is the double-sided adhesive sheet according to any one of the first to thirteenth aspects, wherein the double-sided adhesive sheet is cured by irradiation with light.

[15] A fifteenth aspect of the present invention is an image display device-constituting laminate having a structure in which two image display device-constituting members are laminated via the double-sided adhesive sheet according to any one of the first to fourteenth aspects.

[16] A sixteenth aspect of the present invention is an image display device-constituting laminate having a structure in which two image display device-constituting members are laminated via a cured adhesive sheet obtained by curing the double-sided adhesive sheet according to any one of the first to fourteenth aspects.

[17] A seventeenth aspect of the present invention is the image display device-constituting laminate according to the sixteenth aspect, wherein the cured adhesive sheet has a gel fraction of 40% to 90%.

[18] An eighteenth aspect of the present invention is an image display device constituted using the image display device-constituting laminate according to any one of the fifteenth to seventeenth aspects.

### Effect of the Invention

The double-sided adhesive sheet proposed by the present invention can prevent ultraviolet degradation not only of an adherend, which is an image display device-constituting member, but also of the adhesive sheet itself, i.e., both an intermediate layer (α layer) and a surface layer (β layer), by the action of the ultraviolet absorber contained in the surface layer (β layer), thereby providing excellent discoloration resistance. In addition, the double-sided adhesive sheet proposed by the present invention has a predetermined stress relaxation rate and excellent step absorbability. Therefore, it can be suitably used for various image display device-constituting members.

### MODE(S) FOR CARRYING OUT THE INVENTION

An example of embodiments of the present invention is described below. The present invention, however, is not intended to be limited to the embodiments described below.

### <<Double-Sided Adhesive Sheet of Present Invention>>

The double-sided adhesive sheet according to an example of the embodiments of the present invention (referred to as the “present adhesive sheet”) is a double-sided adhesive sheet having a laminate structure with an intermediate layer (α layer) and a surface layer (β layer), and is preferably a double-sided adhesive sheet having photocurability.

The phrase “having photocurability” means having a property of being curable by active energy rays, in other words, having active energy ray curability that leaves room for curing by active energy rays.

The present adhesive sheet may be cured in a state where there is room left for curing by active energy rays (also referred to as “temporary curing” or “primary curing”), or it may not be cured at all (referred to as “uncuring”) and be curable by active energy rays.

When the present adhesive sheet is temporarily-cured or uncured, the present adhesive sheet can be cured by active energy rays (also referred to as “main curing” or “secondary curing”) before or after the present adhesive sheet is bonded to an adherend, and as a result, the cohesive force can be increased to improve the adhesiveness.

Whether or not the present adhesive sheet is in a state after main curing can be determined as follows: for example, the present adhesive sheet in this state is irradiated with active energy rays having an accumulated light amount of 3,000 mJ/cm² based on a wavelength of 365 nm using an accumulated UV meter (UIT-250 and UVD-C365, manufactured by Ushio Inc.), and if the gel fraction changes by less than 10%, it can be confirmed that the present adhesive sheet is in a state after main curing (secondary curing).

### <Surface Layer (β Layer)>

The surface layer (β layer) is preferably formed from a β layer-forming resin composition containing a (meth)acrylic polymer, a crosslinking agent, a photopolymerization initiator that can be activated by light having a wavelength of 405 nm or more, and an ultraviolet absorber.

### ((Meth)Acrylic Polymer)

The β layer-forming resin composition contains a (meth)acrylic polymer, in particular as a main component resin.

In other words, the (meth)acrylic polymer is a resin with the highest mass ratio among the resins constituting the surface layer (β layer) or the β layer-forming resin composition. In this case, the mass ratio of the (meth)acrylic polymer to the resins constituting the β layer-forming resin composition may be 50% by mass or more, may be 70% by mass or more, may be 80% by mass or more, or may be 90% by mass or more (including 100% by mass).

The (meth)acrylic polymer is preferably one containing a structural unit derived from a compound represented by the following formula 1 (wherein R₁ represents a hydrogen atom or a methyl group, and R₂ represents a linear or branched alkyl group having 4 to 20, preferably 4 to 18, carbon atoms, or an alicyclic hydrocarbon), and more preferably one obtained by polymerizing a polymerization component containing 50% by mass or more of the monomer component having the structural unit.

Among them, the (meta) acrylic polymer is more preferably one obtained by polymerizing a polymerization component containing 55% by mass or more of the monomer component, particularly preferably 60% by mass or more.

In the present invention, the term “(meth)acrylic” is intended to include acrylic and methacrylic; the term “(meth)acryloyl” is intended to include acryloyl and methacryloyl; the term “(meth)acrylate” is intended to include acrylate and methacrylate; and the term “(co) polymer” is intended to include a polymer and a copolymer.

CH₂═CH(R₁)—COO(R₂) formula 1

Examples of the monomer represented by the formula 1 include n-butyl (meth)acrylate, isobutyl (meth)acrylate, sec-butyl (meth)acrylate, t-butyl (meth)acrylate, pentyl (meth)acrylate, isopentyl (meth)acrylate, neopentyl (meth)acrylate, hexyl (meth)acrylate, cyclohexyl (meth)acrylate, heptyl (meth)acrylate, 2-ethylhexyl (meth)acrylate, n-octyl (meth)acrylate, isooctyl (meth)acrylate, nonyl (meth)acrylate, isononyl (meth)acrylate, t-butylcyclohexyl (meth)acrylate, decyl (meth)acrylate, isodecyl (meth)acrylate, undecyl (meth)acrylate, lauryl (meth)acrylate, tridecyl (meth)acrylate, tetradecyl (meth)acrylate, cetyl (meth)acrylate, stearyl (meth)acrylate, isostearyl (meth)acrylate, isobornyl (meth)acrylate, 3,5,5-trimethylcyclohexane (meth)acrylate, dicyclopentanyl (meth)acrylate, and dicyclopentenyl (meth)acrylate. These may be used alone or in combination of two or more types thereof. Among them, it is particularly preferred to include one or more of butyl (meth)acrylate, 2-ethylhexyl (meth)acrylate, n-octyl (meth)acrylate, isooctyl (meth)acrylate, and lauryl (meth)acrylate.

The (meth)acrylic polymer is preferably a copolymer having “other copolymerizable monomer” other than the above monomer components as a copolymerization component.

The “other copolymerizable monomer” is contained in the (meth)acrylic polymer preferably in a ratio of 1% by mass to 30% by mass, more preferably in a ratio of 2% by mass or more or 25% by mass or less.

Examples of the “other copolymerizable monomer” include a carboxy group-containing monomer (a), a hydroxyl group-containing monomer (b), an amino group-containing monomer (c), an epoxy group-containing monomer (d), an amide group-containing monomer (e), a vinyl monomer (f), a (meth)acrylate monomer having an alkyl group with 1 to 3 carbon atoms (g), a macromonomer (h), an aromatic group-containing monomer (i), and other functional group-containing monomer (j). These may be used alone or in combination of two or more types thereof.

Examples of the carboxy group-containing monomer (a) include (meth)acrylic acid, carboxyethyl (meth)acrylate, carboxypropyl (meth)acrylate, carboxybutyl (meth)acrylate, ω-carboxypolycaprolactone mono(meth)acrylate, 2-(meth)acryloyloxyethyl hexahydrophthalic acid, 2-(meth)acryloyloxypropyl hexahydrophthalic acid, 2-(meth)acryloyloxyethyl phthalic acid, 2-(meth)acryloyloxypropyl phthalic acid, 2-(meth)acryloyloxyethyl maleic acid, 2-(meth)acryloyloxypropyl maleic acid, 2-(meth)acryloyloxyethyl succinic acid, 2-(meth)acryloyloxypropyl succinic acid, crotonic acid, fumaric acid, maleic acid, and itaconic acid. These may be used alone or in combination of two or more types thereof.

Examples of the hydroxyl group-containing monomer (b) include hydroxyalkyl (meth)acrylates such as 2-hydroxyethyl (meth)acrylate, 2-hydroxypropyl (meth)acrylate, 2-hydroxy-1-methylethyl acrylate, 3-hydroxypropyl (meth)acrylate, 2-hydroxybutyl (meth)acrylate, 4-hydroxybutyl (meth)acrylate, glycerin mono(meth)acrylate, polyethylene glycol mono(meth)acrylate, polypropylene glycol mono(meth)acrylate, polyethylene glycol polypropylene glycol mono(meth)acrylate, polyethylene glycol polybutylene glycol mono(meth)acrylate, polypropylene glycol polybutylene glycol mono(meth)acrylate, and hydroxyphenyl (meth)acrylate. These may be used alone or in combination of two or more types thereof.

Examples of the amino group-containing monomer (c) include aminoalkyl (meth)acrylates such as aminomethyl (meth)acrylate, aminoethyl (meth)acrylate, aminopropyl (meth)acrylate, and aminoisopropyl (meth)acrylate; N-alkylaminoalkyl (meth)acrylates; and N, N-dialkylaminoalkyl (meth)acrylates such as N, N-dimethylaminoethyl (meth)acrylate and N, N-dimethylaminopropyl (meth)acrylate. These may be used alone or in combination of two or more types thereof.

Examples of the epoxy group-containing monomer (d) include glycidyl (meth)acrylate, methylglycidyl (meth)acrylate, 3,4-epoxycyclohexylmethyl (meth)acrylate, and 4-hydroxybutyl (meth)acrylate glycidyl ether. These may be used alone or in combination of two or more types thereof.

Examples of the amide group-containing monomer (e) include (meth)acrylamide, N, N-dimethyl (meth)acrylamide, N-butyl (meth)acrylamide, N-methylol (meth)acrylamide, N-methylolpropane (meth)acrylamide, N-methoxymethyl (meth)acrylamide, N-butoxymethyl (meth)acrylamide, diacetone (meth)acrylamide, maleic acid amide, and maleimide. These may be used alone or in combination of two or more types thereof.

Examples of the vinyl monomer (f) include compounds having a vinyl group in the molecule. Examples of such compounds include functional monomers having a functional group such as an alkoxyalkyl group, such as ethoxydiethylene glycol acrylate, methoxytriethylene glycol acrylate, methoxypolyethylene glycol acrylate, methoxydipropylene glycol acrylate, and methoxypolypropylene glycol acrylate; polyalkylene glycol di(meth)acrylates; vinyl ester monomers such as vinyl acetate, N-vinyl-2-pyrrolidone, vinyl propionate, and vinyl laurate; and aromatic vinyl monomers such as styrene, chlorostyrene, chloromethylstyrene, α-methylstyrene, and other substituted styrenes. These may be used alone or in combination of two or more types thereof.

Examples of the (meth)acrylate monomer having an alkyl group with 1 to 3 carbon atoms (g) include methyl (meth)acrylate, ethyl (meth)acrylate, n-propyl (meth)acrylate, and i-propyl (meth)acrylate. These may be used alone or in combination of two or more types thereof.

The macromonomer (h) is a high-molecular monomer having a terminal functional group and a high-molecular weight skeleton component.

When the “other copolymerizable monomer” is the macromonomer, the (meth)acrylic polymer is a copolymer containing a structural unit derived from the macromonomer.

The skeleton component of the macromonomer is preferably composed of an acrylic acid ester polymer or a vinyl-based polymer. Examples of the macromonomer include (meth)acrylates having a linear or branched alkyl group with 4 to 20 carbon atoms, the carboxy group-containing monomer, the hydroxyl group-containing monomer, the vinyl monomer, and the (meth)acrylate monomer having an alkyl group with 1 to 3 carbon atoms; and these may be used alone or in combination of two or more types thereof.

The number average molecular weight of the macromonomer is preferably 1,000 or more, more preferably 1,500 or more, and even more preferably 2,000 or more. The upper limit of the number average molecular weight is generally 20,000.

It is preferred that the macromonomer is a macromonomer copolymerized with a (meth)acrylate having a linear or branched alkyl group with 1 to 3 carbon atoms, from the viewpoint of improving processability and storage stability.

The number average molecular weight of such a macromonomer is preferably 1,000 to 10,000, more preferably 1,500 or more or 5,000 or less, and even more preferably 2,000 or more or 4,000 or less.

It is also preferred that the macromonomer is a macromonomer copolymerized with a (meth)acrylate having a linear or branched alkyl group with 8 to 20 carbon atoms, from the viewpoint of improving unevenness followability even when the adherend surface is uneven.

The number average molecular weight of such a macromonomer is preferably 2,000 to 20,000, more preferably 3,000 or more or 15,000 or less, and even more preferably 4,000 or more or 10,000 or less.

The macromonomer can be used to introduce as a branch component of a graft copolymer and form a (meth)acrylic acid ester copolymer into a graft copolymer. For example, it can be formed into a (meth)acrylic polymer composed of a copolymer containing a structural unit derived from the macromonomer as a branch component.

Therefore, the characteristics of the main and side chains of the graft copolymer can be modified by the selection and blending ratio of the macromonomer and other monomers.

In particular, the copolymerization ratio of the macromonomer to the (meth)acrylic polymer is preferably 30% by mass or less from the viewpoint of imparting fluidity during hot-melting, more preferably 2% by mass or more or 15% by mass or less, even more preferably 3% by mass or more or 10% by mass or less, and particularly preferably 4% by mass or more or 7% by mass or less.

Examples of the aromatic group-containing monomer (i) include benzyl (meth)acrylate, phenoxyethyl (meth)acrylate, 2-hydroxy-3-phenoxypropyl (meth)acrylate, and nonylphenol EO-modified (meth)acrylate. These may be used alone or in combination of two or more types thereof.

Examples of the other functional group-containing monomer (j) include (meth)acrylic-modified silicone, and fluorine-containing monomers such as 2-acryloyloxyethyl acid phosphate, 2,2,2-trifluoroethyl (meth)acrylate, 2,2,3,3-tetrafluoropropyl (meth)acrylate, 1H,1H,5H-octafluoropentyl (meth)acrylate, and 1H,1H,2H,2H-tridecafluoro-n-octyl (meth)acrylate. These may be used alone or in combination of two or more types thereof.

It is preferred that the (meth)acrylic polymer contains no or substantially no “carboxy group-containing monomer” from the viewpoint of metal corrosion resistance and wet heat whitening resistance.

The phrase “contain no or substantially no carboxyl group-containing monomer” means not only the case where the carboxy group-containing monomer is completely absent, but also the case where the carboxy group-containing monomer is present in the (meth)acrylic acid ester (co) polymer in a ratio of 0.5% by mass or less, preferably 0.1% by mass or less.

It is preferred that the glass transition temperature of at least one of the repeating units derived from (meth)acrylic acid ester of the acrylic polymer is −70° C. to 0° C.

The glass transition temperature of the copolymer component means a value calculated by the Fox's calculation formula from the glass transition temperature and composition ratio of a polymer obtained from a homopolymer of each component of the copolymer.

The Fox's calculation formula provides a calculated value obtained by the following formula, and can be determined using values described in Polymer Hand Book, J. Brandrup, Interscience, 1989:

$$1 / ( 273 + Tg ) = Σ ( Wi / ( 273 + Tgi ) ) ,$$

wherein Wi represents a mass fraction of a monomer i, and Tgi represents a Tg (° C.) of a homopolymer of the monomer i.

In obtaining the above (meth)acrylic polymer, it is preferred that the glass transition temperature of at least one of the repeating units derived from (meth)acrylic acid ester of the acrylic polymer is −70° C. to 0° C.

Examples of the (meth)acrylic acid ester constituting such repeating units include, but are not limited to, n-butyl acrylate, n-hexyl acrylate, n-octyl acrylate, n-nonyl acrylate, n-decyl acrylate, 2-ethylhexyl acrylate, 2-ethylhexyl methacrylate, 2-methylhexyl acrylate, isooctyl acrylate, isononyl acrylate, isodecyl acrylate, isodecyl methacrylate, isostearyl acrylate, isostearyl (meth)acrylate, multi-branched stearyl acrylate, and multi-branched stearyl (meth)acrylate.

It is also preferred that the glass transition temperature of at least one of the repeating units derived from (meth)acrylic acid ester of the (meth)acrylic polymer is 20° C. to 120° C., because excellent processability and storage stability can be maintained. Specifically, the glass transition temperature (Tg) thereof is preferably 30° C. to 120° C., more preferably 40° C. or higher or 110° C. or lower, and even more preferably 50° C. or higher or 100° C. or lower, because it affects a hot-melt temperature of the present adhesive sheet.

With repeating units having such a glass transition temperature (Tg), the molecular weight can be adjusted to maintain excellent processability and storage stability, and hot-melt at 50° C. or higher.

Examples of the (meth)acrylic acid ester constituting such repeating units include methyl acrylate, ethyl methacrylate, n-propyl acrylate, n-propyl methacrylate, isopropyl acrylate, isopropyl methacrylate, n-butyl methacrylate, t-butyl acrylate, isobutyl acrylate, isobutyl methacrylate, isobornyl acrylate, cyclohexyl acrylate, cyclohexyl methacrylate, 1,4-cyclohexanedimethanol monoacrylate, tetrahydrofurfuryl methacrylate, benzyl acrylate, benzyl methacrylate, phenoxyethyl acrylate, and phenoxyethyl methacrylate.

It is preferred that all of the repeating units derived from (meth)acrylic acid ester of the acrylic polymer have a glass transition temperature of −70° C. to 20° C., because even when the adherend has an unevenness on the adherend surface, the unevenness followability can be further improved.

Among the above, the (meth)acrylic polymer is preferably a block copolymer and/or a graft copolymer from the viewpoint of imparting hot-melt properties to the adhesive agent.

By having the (meth)acrylic polymer be a block copolymer or a graft copolymer, it is possible to form an adhesive sheet excellent in shape stability and hot-melt properties.

Herein, the block copolymer refers to a copolymer having a plurality of polymer chains containing repeating units derived from (meth)acrylic acid ester, wherein the plurality of these polymer chains having different chemical structures are linearly bonded.

It is preferred that some blocks of the block copolymer contain repeating units derived from a macromonomer.

The graft copolymer is a copolymer containing repeating units derived from (meth)acrylic ester as a trunk component, and has a structure such as a comb-type polymer, brush-shaped polymer, star polymer, palm-tree-shaped polymer, or dumbbell polymer, depending on the method of introducing a branch component.

The graft copolymer is preferably a copolymer containing repeating units derived from a macromonomer as a branch component.

When the (meth)acrylic polymer is a copolymer containing a structural unit derived from a macromonomer as described above, the copolymerization ratio of the macromonomer is preferably 2% by mass or more because hot-melt properties can be imparted; and when the adhesive sheet is laminated to the image display device constituent member described below to form a laminate, it is preferably 30% by mass or less because delamination or the like does not occur during bending and durability is improved, thereby facilitating adjustment of the stress relaxation rate within a predetermined range.

From such a viewpoint, the copolymerization ratio of the macromonomer to the (meth)acrylic polymer is preferably 2% by mass or more, more preferably 38 by mass or more, and even more preferably 4% by mass or more. In addition, it is preferably 30% by mass or less, more preferably 15% by mass or less, even more preferably 10% by mass or less, still more preferably 8% by mass or less, and still more preferably 7% by mass or less.

When the macromonomer used is a (meth)acrylic polymer using a macromonomer copolymerized with a (meth)acrylate having a linear or branched alkyl group with 1 to 3 carbon atoms, the glass transition temperature of the repeating units derived from the macromonomer is preferably 20° C. to 150° C., more preferably 40° C. or higher or 130° C. or lower, and even more preferably 60° C. or higher or 120° C. or lower.

When the (meth)acrylic polymer is a block copolymer and/or a graft copolymer, the content of the copolymerization component having a glass transition temperature in the above range is preferably 3% by mass or more, more preferably 4% by mass or more, relative to the (meth)acrylic polymer for the same reason as described above. In addition, it is preferably 10% by mass or less, more preferably 9% by mass or less, even more preferably 8% by mass or less, and still more preferably 7% by mass or less.

The mass average molecular weight of the (meth)acrylic polymer is preferably 150,000 or more, more preferably 200,000 or more, even more preferably 250,000 or more, and still more preferably 300,000 or more, from the viewpoint of increasing the cohesive force of the present adhesive sheet. In addition, it is preferably 1,500,000 or less, more preferably 1,200,000 or less, even more preferably 1, 100,000 or less, and still more preferably 1,000,000 or less, from the viewpoint of ease of adjusting the stress relaxation rate of the present adhesive sheet to a predetermined range, ease of handling, and uniform stirring.

The glass transition temperature (Tg) of the (meth)acrylic polymer is preferably −80° C. or higher, more preferably −70° C. or higher, even more preferably −60° C. or higher, and still more preferably −50° C. or higher, from the viewpoint of increasing the dimensional stability under storage conditions of the present adhesive sheet. In addition, it is preferably 25° C. or lower, more preferably 20° C. or lower, even more preferably 15° C. or lower, and still more preferably 10° C. or lower, from the viewpoint of wettability and tack development on the adherend.

### (Crosslinking Agent)

The crosslinking agent forms a crosslinked structure in the acrylic polymer, and the crosslinked structure includes a chemical crosslinked structure and a physical crosslinked structure. Examples of such a crosslinking agent include crosslinking agents having at least one crosslinking functional group selected from an epoxy group, an isocyanate group, a carboxy group, a hydroxy group, a carbodiimide group, an oxazoline group, an aziridine group, a vinyl group, an amino group, an imino group, an amide group, and a (meth)acryloyl group. Among them, crosslinking agents having at least double bond crosslinking are preferred, especially those having a (meth)acryloyl group. These crosslinking agents may be used alone or in combination of two or more types thereof. Crosslinking agents chemically bonded to the (meth)acrylic polymer are also encompassed.

Among them, a polyfunctional (meth)acrylate is preferably used. The polyfunctional refers to one having two or more crosslinking functional groups. It may have three or more, or four or more crosslinking functional groups as necessary.

The crosslinking functional groups may be protected with a deprotectable protective group.

Examples of the polyfunctional (meth)acrylate include ultraviolet-curable polyfunctional (meth)acrylic monomers such as 1,4-butanediol di(meth)acrylate, glycerin di(meth)acrylate, neopentyl glycol di(meth)acrylate, glycerin glycidyl ether di(meth)acrylate, 1,6-hexanediol di(meth)acrylate, 1,9-nonanediol di(meth)acrylate, tricyclodecane dimethacrylate, tricyclodecane dimethanol di(meth)acrylate, bisphenol A polyethoxy di(meth)acrylate, bisphenol A polypropoxy di(meth)acrylate, bisphenol F polyethoxy di(meth)acrylate, ethylene glycol di(meth)acrylate, trimethylolpropane trioxyethyl (meth)acrylate, ε-caprolactone-modified tris(2-hydroxyethyl) isocyanurate tri(meth)acrylate, pentaerythritol tri(meth)acrylate, propoxylated pentaerythritol tri(meth)acrylate, ethoxylated pentaerythritol tri(meth)acrylate, pentaerythritol tetra(meth)acrylate, propoxylated pentaerythritol tetra(meth)acrylate, ethoxylated pentaerythritol tetra(meth)acrylate, dipentaerythritol hexa(meth)acrylate, polyethylene glycol di(meth)acrylate, tris(acryloxyethyl) isocyanurate, dipentaerythritol penta(meth)acrylate, tripentaerythritol hexa(meth)acrylate, tripentaerythritol penta(meth)acrylate, hydroxypivalate neopentyl glycol di(meth)acrylate, di(meth)acrylate of ε-caprolactone adduct of hydroxypivalate neopentylglycol, trimethylolpropane tri(meth)acrylate, trimethylolpropane polyethoxy tri(meth)acrylate, and ditrimethylolpropane tetra(meth)acrylate; and polyfunctional (meth)acrylic oligomers such as polyester (meth)acrylate, epoxy (meth)acrylate, urethane (meth)acrylate, and polyether (meth)acrylate.

The content of the crosslinking agent is not particularly limited.

The content of the crosslinking agent in the surface layer (β layer) is preferably 0.1 to 30 parts by mass, more preferably 0.5 part by mass or more or 20 parts by mass or less, even more preferably 1 part by mass or more or 15 parts by mass or less, and still more preferably 3 parts by mass or more or 10 parts by mass or less, relative to 100 parts by mass of the (meth)acrylic polymer in the β layer-forming resin composition.

By containing the crosslinking agent in the surface layer (β layer) in the above range, the curing reaction proceeds sufficiently in a short period of time, and the adhesive sheet obtained after curing can easily balance tackiness and reliability, discoloration resistance, step absorbability (foreign object biting), flexibility, and processing suitability when formed into a sheet.

### (Photopolymerization Initiator)

The photopolymerization initiator functions as a reaction initiation aid in the crosslinking reaction of the crosslinking agent described above, and in the present invention, it is important to use a photopolymerization initiator that can be activated by light having a wavelength of 405 nm or more.

The photopolymerization initiator is preferably one that can be activated, for example, by irradiation with light rays including a wavelength region of 380 to 700 nm, in other words, one that generates radicals and becomes the starting point for the polymerization reaction of the base resin with light in a region not absorbed by an ultraviolet absorber, i.e., light having a wavelength range of 405 nm or more.

However, it may be one that generates radicals only by irradiation with visible rays, or it may be one that generates radicals with light having a wavelength in the ultraviolet region as long as it can generate radicals with light in a region not absorbed by an ultraviolet absorber.

Examples of the photopolymerization initiator that generates radicals with light having a wavelength of 405 nm or more include 2-benzyl-2-dimethylamino-1-(4-morpholinophenyl) butan-1-one, 2-(4-methylbenzyl)-2-dimethylamino-1-(4-morpholinophenyl) butan-1-one, bis(2,4,6-trimethylbenzoyl)-phenylphosphine oxide, 2,4,6-trimethylbenzoyldiphenylphosphine oxide, thioxanthone, 2-chlorothioxanthone, 3-methylthioxanthone, 2,4-dimethylthioxanthone, 2-methylanthraquinone, 2-ethylanthraquinone, 2-tert-butylanthraquinone, 2-aminoanthraquinone, 1,2-octanedione, 1-(4-(phenylthio), 2-(o-benzoyloxime)), ethyl phenyl (2,4,6-trimethylbenzoyl)phosphinate, (2,4,6-trimethylbenzoyl) ethoxyphenylphosphine oxide, and bis(2,6-dimethoxybenzoyl)-2,4,4-trimethylpentylphosphine oxide. In addition, photopolymerization initiators chemically bonded to the (meth)acrylic copolymer are also encompassed.

Any one of these or their derivatives may be used.

The photopolymerization initiator is roughly classified into two types in terms of the radical generation mechanism, and is broadly divided into a cleavage-type photopolymerization initiator that can generate radicals by cleaving and decomposing a single bond of the photopolymerization initiator itself and a hydrogen abstraction-type photopolymerization initiator in which a photoexcited initiator and a hydrogen donor in the system can form an excited complex to allow hydrogen of the hydrogen donor to be transferred.

Of these, the cleavage-type photopolymerization initiator is decomposed and converted into another compound when radicals are generated by light irradiation, and has no function as a reaction initiator once excited. Therefore, the cleavage-type photopolymerization initiator is preferred because it does not remain as an active species in an adhesive agent after the crosslinking reaction is completed, and the optical properties are not deteriorated due to unexpected light deterioration such as discoloration of the adhesive agent. For this reason, in the present invention, it is preferable to select, in particular, a cleavage-type photopolymerization initiator as the photopolymerization initiator.

From such a viewpoint, in order to eliminate the problem in which the photopolymerization initiator remains as an active species after photocuring and causes, for example, discoloration to deteriorate the optical properties, it is preferred in the present invention that the surface layer (β layer) or the present adhesive sheet contains substantially no thermal polymerization initiator.

The phrase “contains substantially no” means that it is not intentionally contained, and if it is contained as an unavoidable impurity, it is included as “unavoidable”. Usually, this means that the content of the unavoidable impurity is 0.1% by mass or less, particularly 0.05% by mass or less, relative to the β layer-forming resin composition.

Among the above cleavage-type photopolymerization initiators, acylphosphine oxide-based photopolymerization initiators, such as ethyl phenyl(2,4,6-trimethylbenzoyl)phosphinate, bis(2,4,6-trimethylbenzoyl)-phenylphosphine oxide, 2,4,6-trimethylbenzoyldiphenylphosphine oxide, (2,4,6-trimethylbenzoyl) ethoxyphenylphosphine oxide, and bis(2,6-dimethoxybenzoyl)-2,4,4-trimethylpentylphosphine oxide, are preferred because they convert to decomposed products and decolorize after reaction.

The content of the photopolymerization initiator is not particularly limited.

The content of the photopolymerization initiator is preferably 0.01 to 10 parts by mass, more preferably 0.1 part by mass or more or 5 parts by mass or less, and even more preferably 0.3 part by mass or more or 3 parts by mass or less, relative to 100 parts by mass of the (meth)acrylic polymer in the β layer-forming resin composition.

By adjusting the content of the photopolymerization initiator within the above range, appropriate reaction sensitivity to active energy rays can be obtained.

In addition, the content of the photopolymerization initiator is preferably 1 to 25 parts by mass, more preferably 3 parts by mass or more or 20 parts by mass or less, and even more preferably 5 parts by mass or more or 15 parts by mass or less, relative to 100 parts by mass of the crosslinking agent in the β layer-forming resin composition.

By adjusting the content of the photopolymerization initiator within the above range, good stress relaxation can be obtained.

### (Ultraviolet Absorber)

The ultraviolet absorber may be a substance capable of absorbing ultraviolet rays, and the transmittance of the ultraviolet rays having a wavelength of 365 nm or less of the present adhesive sheet is preferably, as a guideline, 50% or less by the addition of the ultraviolet absorber.

Preferred examples of the ultraviolet absorber include those having one or two or more structures selected from the group consisting of a benzotriazole structure, a benzophenone structure, a triazine structure, a benzoate structure, an oxalanilide structure, a salicylate structure, and a cyanoacrylate structure. Among them, those having a benzotriazole structure, a triazine structure or a benzophenone structure are more preferred from the viewpoint of ultraviolet absorption performance.

The content of the ultraviolet absorber is not particularly limited. The content of the ultraviolet absorber is preferably 0.01 to 10 parts by mass, more preferably 0.1 part by mass or more or 5 parts by mass or less, and even more preferably 0.3 part by mass or more or 3 parts by mass or less, relative to 100 parts by mass of the β layer-forming resin composition.

By adjusting the content of the ultraviolet absorber in the β layer-forming resin composition within the above range, sufficient ultraviolet absorption performance can be obtained without lowering the wet heat resistance reliability, discoloration resistance, whitening resistance, and optical properties (transparency and yellowness) of the present adhesive sheet. In addition, by containing the necessary amount of the ultraviolet absorber in the surface layer (β layer), the ultraviolet absorber can be easily present in the surface layer, and furthermore, there is no need to contain the ultraviolet absorber in the intermediate layer (α layer), thereby reducing the content of the ultraviolet absorber in the present adhesive sheet as a whole.

In the surface layer (β layer), from the viewpoint of absorbing ultraviolet rays and initiating photopolymerization in the visible light region excluding the ultraviolet rays, the content of the ultraviolet absorber is preferably 25 to 400 parts by mass, more preferably 50 parts by mass or more or 300 parts by mass or less, and even more preferably 80 parts by mass or more or 250 parts by mass or less, relative to 100 parts by mass of the photopolymerization initiator.

### (Other Components)

The surface layer (β layer) or the β layer-forming resin composition may contain, as components other than the above, known components blended in ordinary resin compositions. For example, various additives such as a silane coupling agent, a rust inhibitor, a tackifier resin, an antioxidant, a light stabilizer, a metal deactivator, an anti-aging agent, a moisture absorbent, and a hydrolysis inhibitor can be appropriately contained. In particular, it is effective to contain a silane coupling agent in the surface layer (β layer) from the viewpoint of improving the adhesiveness with other members, and it is also effective to contain a rust inhibitor in the surface layer (β layer) from the viewpoint of increasing the rust preventive effect on other members.

In addition, reaction catalysts (such as tertiary amine-based compounds, quaternary ammonium-based compounds, and tin laurate compounds) may be appropriately contained as necessary.

### <Intermediate Layer (α Layer)>

The intermediate layer (α layer) is preferably formed from an α layer-forming resin composition containing a (meth)acrylic polymer, a crosslinking agent, and a photopolymerization initiator.

### ((Meth)Acrylic Polymer)

Examples of the (meth)acrylic polymer contained in the intermediate layer (α layer) or the α layer-forming resin composition can be the same as the (meth)acrylic polymer contained in the surface layer (β layer) or the β layer-forming resin composition.

The (meth)acrylic polymer contained in the intermediate layer (α layer) or the α layer-forming resin composition and the (meth)acrylic polymer contained in the surface layer (β layer) or the β layer-forming resin composition may be the same resin or different resins. In order to adjust the balance between step absorbability and adhesive properties, it is also preferable to use different resins as appropriate.

### (Crosslinking Agent)

Examples of the crosslinking agent contained in the intermediate layer (α layer) or the α layer-forming resin composition can be the same as the crosslinking agent contained in the surface layer (β layer) or the β layer-forming resin composition.

The crosslinking agent contained in the intermediate layer (α layer) or the α layer-forming resin composition and the crosslinking agent contained in the surface layer (β layer) or the β layer-forming resin composition may be the same compound or different compounds. In the present invention, it is preferable to use different types and amounts of crosslinking agents in order to separate the function of each layer from the viewpoint of balancing the physical properties of the adhesive sheet.

The crosslinking agent contained in the intermediate layer (α layer) or the α layer-forming resin composition is preferably a polyfunctional monomer or an oligomer containing a polar functional group such as a hydroxyl group or a carboxy group from the viewpoint of the effects of improving adhesion to the surface layer (β layer) and suppressing wet heat whitening. Among them, it is more preferable to use a polyfunctional (meth)acrylic monomer having a hydroxyl group.

The content of the crosslinking agent in the α layer-forming resin composition is preferably 0.1 to 50 parts by mass, more preferably 0.5 part by mass or more or 40 parts by mass or less, even more preferably 1 part by mass or more or 30 parts by mass or less, and still more preferably 5 parts by mass or more or 20 parts by mass or less, relative to 100 parts by mass of the acrylic polymer in the α layer-forming resin composition.

By containing the crosslinking agent in the above range, the curing reaction proceeds sufficiently in a short period of time, which facilitates balancing reliability after curing and wet heat whitening resistance, flexibility, and processing suitability when formed into a sheet.

### (Photopolymerization Initiator)

Examples of the photopolymerization initiator contained in the intermediate layer (α layer) or the α layer-forming resin composition can be the same as the photopolymerization initiator contained in the surface layer (β layer) or the β layer-forming resin composition. Specifically, the photopolymerization initiator is preferably one that can be activated by light having a wavelength of 405 nm or more, and further, it is preferable to select a cleavage-type photopolymerization initiator because it does not remain as an active species in an adhesive agent after the crosslinking reaction is completed, and the optical properties are not deteriorated due to unexpected light deterioration such as discoloration of the adhesive agent.

The photopolymerization initiator contained in the intermediate layer (α layer) or the α layer-forming resin composition and the photopolymerization initiator contained in the surface layer (β layer) or the β layer-forming resin composition may be the same compound or different compounds.

It is preferred that the intermediate layer (α layer) or the present adhesive sheet contains substantially no thermal polymerization initiator.

The phrase “contains substantially no” means that it is intentionally not contained, and includes the case where it is contained as an unavoidable impurity. Usually, this means that the content of the unavoidable impurity is 0.1% by mass or less, particularly 0.05% by mass or less, relative to the α layer-forming resin composition.

The content of the photopolymerization initiator in the intermediate layer (α layer) or the α layer-forming resin composition is not particularly limited.

The content of the photopolymerization initiator in the α layer-forming resin composition is preferably 0.01 to 10 parts by mass, more preferably 0.1 part by mass or more or 5 parts by mass or less, and even more preferably 0.3 part by mass or more or 3 parts by mass or less, relative to 100 parts by mass of the (meth)acrylic polymer in the α layer-forming resin composition.

By adjusting the content of the photopolymerization initiator within the above range, appropriate reaction sensitivity to active energy rays can be obtained.

In addition, the content of the photopolymerization initiator in the α layer-forming resin composition is preferably 1 to 25 parts by mass, more preferably 3 parts by mass or more or 20 parts by mass or less, and even more preferably 5 parts by mass or more or 15 parts by mass or less, relative to 100 parts by mass of the crosslinking agent in the α layer-forming resin composition

By adjusting the content of the photopolymerization initiator within the above range, good stress relaxation can be obtained.

### (Ultraviolet Absorber)

The intermediate layer (α layer) or the α layer-forming resin composition may contain an ultraviolet absorber as necessary. However, it does not necessarily need to contain an ultraviolet absorber.

When the intermediate layer (α layer) or the α layer-forming resin composition contains an ultraviolet absorber, examples of the ultraviolet absorber contained in the intermediate layer (α layer) or the α layer-forming resin composition can be the same as the ultraviolet absorber contained in the surface layer (β layer) or the β layer-forming resin composition.

The ultraviolet absorber contained in the intermediate layer (α layer) or the α layer-forming resin composition and the ultraviolet absorber contained in the surface layer (β layer) or the β layer-forming resin composition may be the same compound or different compounds.

When the intermediate layer (α layer) or the α layer-forming resin composition contains an ultraviolet absorber, the content thereof may be adjusted within a range that does not interfere with the effects of the present invention. For example, the content thereof is preferably 10 parts by mass or less, more preferably 5 parts by mass or less, and even more preferably 3 parts by mass or less, relative to 100 parts by mass of the (meth)acrylic polymer in the α layer-forming resin composition.

In the present invention, the intermediate layer (α layer) preferably has a concentration of the ultraviolet absorber lower than that of the ultraviolet absorber in the surface layer (β layer), and the difference in concentration between the two is preferably 0.1% by mass or more, more preferably 0.3% by mass or more.

In particular, it is preferred that the intermediate layer (α layer) or the α layer-forming resin composition contains substantially no ultraviolet absorber.

The term substantially means that the content of the ultraviolet absorber is 0.1% by mass or less, particularly 0.05% by mass or less, relative to the α layer-forming resin composition.

### (Others)

The intermediate layer (α layer) or the α layer-forming resin composition may contain, as components other than the above, known components blended in ordinary resin compositions. For example, various additives such as a tackifier resin, an antioxidant, a light stabilizer, a metal deactivator, a rust inhibitor, an anti-aging agent, a moisture absorbent, and a hydrolysis inhibitor can be appropriately contained.

In addition, reaction catalysts (such as tertiary amine-based compounds, quaternary ammonium-based compounds, and tin laurate compounds) may be appropriately contained as necessary.

### (Preferred Composition Example)

As an example of a particularly preferred composition of the present adhesive sheet, an example can be cited in which the surface layer (β layer) is formed from a resin composition containing a (meth)acrylic polymer, a crosslinking agent, a photopolymerization initiator that can be activated by light having a wavelength of 405 nm or more, and an ultraviolet absorber, and the intermediate layer (α layer) is formed from a resin composition containing a (meth)acrylic polymer, a crosslinking agent, and a photopolymerization initiator that can be activated by irradiation with light in a region not absorbed by the ultraviolet absorber. The photopolymerization initiator that can be activated by light having a wavelength of 405 nm or more is preferably a cleavage-type photopolymerization initiator.

As described above, it is preferred that the resin compositions forming the surface layer (β layer) and the intermediate layer (α layer) each have a different composition according to the function of each layer, even if, for example, the (meth)acrylic polymer is the same.

### <Laminate Structure>

The present adhesive sheet has a laminate structure including an α layer as an intermediate layer and a β layer as an outermost surface layer.

In this case, it is preferred that the present adhesive sheet has three or more layers because the β layer serves as the outermost surface layer to bond the adhesive sheet to other members as well as to prevent ultraviolet degradation. With a laminate structure of three or more layers, the functions required for each layer can be divided, which facilitates achieving, for example, both step absorbability and adhesive properties (such as adhesive strength and holding force).

Specific examples of the laminate structure of the present adhesive sheet include β layer/α layer/β layer and β layer/α layer/γ layer/α layer/β layer. Among them, a laminate structure of two types and three layers, which is β layer/α layer/β layer, is more preferred. The γ layer is an arbitrary intermediate layer having a composition different from that of the α layer.

Other layers such as an outgas barrier layer and a shock absorbing layer may be interposed between the α layer and the β layer as necessary.

### <Thickness>

The thickness of each intermediate layer (α layer) is preferably 10 to 400 μm, more preferably 30 μm or more or 300 μm or less, even more preferably 50 μm or more or 250 μm or less, and still more preferably 100 μm or more or 200 μm or less.

The thickness of each surface layer (β layer) is preferably 1 to 200 μm, more preferably 10 μm or more or 150 μm or less, even more preferably 30 μm or more or 100 μm or less, and still more preferably 40 μm or more or 80 μm or less.

When the thickness of each surface layer (β layer) is within the above range, the adhesive strength and wettability to the adherend, as well as the step absorbability, can be maintained.

The ratio (α/β) of the thickness of each intermediate layer (α layer) to the thickness of each surface layer (β layer) is preferably 1 to 10, more preferably 1.5 or more or 7 or less, even more preferably 2 or more or 5 or less, and still more preferably 2.5 or more or 3.5 or less.

When the thickness of each intermediate layer (α layer) is within the above range, it is possible to impart a stiffness to the present adhesive sheet, and it is preferred that the workability for cutting and handling not be inferior by being too flexible.

The thickness of the present adhesive sheet is preferably 20 to 450 μm, more preferably 40 μm or more or 350 μm or less, and even more preferably 50 μm or more or 300 μm or less.

When the thickness satisfies the above range, it is possible to meet the demand for thinning, and at the same time, it is possible to sufficiently satisfy the adhesive force to the adherend surface and the unevenness followability.

### <Characteristics>

The physical properties and characteristics of the present adhesive sheet are described below.

### (Stress Relaxation Rate)

The present adhesive sheet, i.e., the present adhesive sheet before main curing, preferably has a stress relaxation rate, which is calculated as follows, of 30%, more preferably 40% or more, and even more preferably 45% or more, from the viewpoint of step absorbability. The upper limit thereof is preferably 100% or less, particularly preferably 99% or less.

The stress values (X) and (Y) of the present adhesive sheet before main curing are determined, for example, by the following method.

A plurality of the adhesive sheets are laminated to prepare a sheet having a thickness of 0.8 to 1.2 mm (approximately 0.8 mm); the sheet is punched out into a circle shape having a diameter of 8 mm to prepare a sample; the sample is subjected to a measurement after applying 25% strain to the sample by shearing under the conditions where the adhesive jig is Φ8 mm parallel plate and the measurement environment is 25° C. by using a rheometer (DHR-2, manufactured by TA Instruments Japan Inc.); and the stress value measured after the elapse of 10 seconds can be measured as the stress value (X) and the stress value measured after the elapse of 300 seconds can be measured as the stress value (Y).

The aforementioned “a plurality of the adhesive sheets are laminated to prepare a sheet having a thickness of 0.8 to 1.2 mm” means that when the thickness of the adhesive sheet as a measurement sample is less than the range, the thickness of the measurement sample is adjusted to the range by laminating a plurality of adhesive sheets. The same applies to other tests where the thickness of the measurement sample is specified.

When the thickness of the adhesive sheet is between 0.8 mm and 1.2 mm, the difference in thickness is not expected to affect the stress value.

In the present invention, the stress value (X) of the adhesive sheet before main curing is preferably 5,000 to 500,000 Pa, more preferably 10,000 Pa or more or 300,000 Pa or less, even more preferably 15,000 Pa or more or 200,000 Pa or less, still more preferably 15,000 Pa or more or 100,000 Pa or less, and particularly preferably 18,000 Pa or more or 35,000 Pa or less. It is preferred that the stress value (X) is within the above range because the holding force is high and less likely to drop.

The stress value (Y) is preferably 5,000 to 300,000 Pa, more preferably 7,000 Pa or more or 200,000 Pa or less, even more preferably 8,000 Pa or more or 100,000 Pa or less, still more preferably 9,000 Pa or more or 50,000 Pa or less, and particularly preferably 10,000 Pa or more or 15,000 Pa or less. It is preferred that the stress value (Y) is within the above range because the step absorbability is high.

In order to adjust the stress relaxation rate of the present adhesive sheet within the above range, a method of selecting the type of a (meth)acrylic polymer, such as using a (meth)acrylic polymer having a low copolymerization ratio of a macromonomer or a (meth)acrylic polymer having a low mass average molecular weight, a method of selecting the type of a crosslinking agent, and a method of reducing the content of a crosslinking agent, can be cited. However, it is not limited to these methods.

Since the present adhesive sheet is an adhesive sheet having a laminate structure, the resin compositions in the intermediate layer and the surface layer can each be adjusted separately, which is more advantageous than an adhesive sheet having a single-layer structure in that it is much easier to adjust the stress relaxation rate or the like compared to an adhesive sheet having a single-layer structure.

The present adhesive sheet can be cured by light irradiation, and the stress relaxation rate of the present adhesive sheet after main curing is preferably 10% or more, more preferably 20% or more, even more preferably 30% or more, and particularly preferably 40% or more, from the viewpoint of step absorbability. The upper limit thereof is preferably 99% or less, particularly preferably 85% or less.

The stress value (X) of the adhesive sheet after main curing is preferably 10,000 to 50,000 Pa, more preferably 11,000 Pa or more or 45,000 Pa or less, even more preferably 13,000 Pa or more or 42,000 Pa or less, and particularly preferably 15,000 Pa or more or 40,000 Pa or less. It is preferred that the stress value (X) is within the above range in terms of easy step absorption.

The stress value (Y) is preferably 1,000 to 35,000 Pa, more preferably 3,000 Pa or more or 30,000 Pa or less, even more preferably 5,000 Pa or more or 25,000 Pa or less, and particularly preferably 7,000 Pa or more or 20,000 Pa or less. It is preferred that the stress value (Y) is within the above range in terms of easy step absorption.

In order to adjust the stress relaxation rate of the present adhesive sheet after main curing within the above range, in the same manner as above, for example, a method of selecting the type of a (meth)acrylic polymer, such as using a (meth)acrylic polymer having a low macromonomer content part or a (meth)acrylic polymer having a low mass average molecular weight, a method of selecting the type of a crosslinking agent, and a method of reducing the content of a crosslinking agent, can be cited. However, it is not limited to these methods.

### (Gel Fraction)

The present adhesive sheet, i.e., the present adhesive sheet before main curing, preferably has a gel fraction of 20% to 70%, more preferably 30% or more or 60% or less, and even more preferably 40% or more or 55% or less, from the viewpoint of good handling and excellent step absorbability.

In order to adjust the gel fraction of the present adhesive sheet within the above range, for example, a method of photocuring a sheet in a state where there is room left for photocuring, and a method of photocuring a sheet by reducing the accumulated light amount of light to be irradiated, can be cited. However, it is not limited to such methods.

The method of measuring the gel fraction of the adhesive sheet may be the same as that used in Examples.

The present adhesive sheet can be cured by light irradiation, and the gel fraction of the present adhesive sheet after main curing is preferably 40% to 90%, more preferably 45% or more or 80% or less, and even more preferably 50% or more or 70% or less, from the viewpoint of maintaining the adhesive force.

In order to adjust the gel fraction of the present adhesive sheet within the above range, for example, a method of adjusting the blending amount of a crosslinking agent and a method of adjusting the accumulated light amount of light to be irradiated, can be cited. However, it is not limited to such methods.

The method of measuring the gel fraction of the adhesive sheet after curing may be the same as that used in Examples.

Since the present adhesive sheet can be cured by light irradiation, the gel fraction of the present adhesive sheet after curing can be made higher than that of the present adhesive sheet before curing. In this case, the difference in gel fraction before and after main curing may be 3% to 30%, of which 5% or more or 20% or less, of which 7% or more or 15% or less.

In order to adjust the difference in gel fraction before and after main curing, for example, a method of adjusting the blending amount of a crosslinking agent and a method of adjusting the accumulated light amount of light to be irradiated, can be cited. However, it is not limited to such methods.

### (Spectral Characteristics)

The present adhesive sheet is preferably photocurable during film formation, and is characterized by having ultraviolet absorption performance.

The present adhesive sheet preferably has a light transmittance at a wavelength of 365 nm or less of 50% or less, more preferably 45% or less, and even more preferably 40% or less, from the viewpoint of preventing ultraviolet degradation of adherends, which are image display device-constituting members.

With respect to the ultraviolet absorption performance of the present adhesive sheet, the light transmittances at wavelengths of 320 nm, 340 nm, and 365 nm are each preferably 70% or less, more preferably 50% or less, and even more preferably 20% or less.

The light transmittances at wavelengths of 380 nm and 395 nm are each preferably 10% to 90%, more preferably 30% or more or 88% or less, and even more preferably 50% or more or 85% or less. The light transmittance at a wavelength of 420 nm is preferably 70% or more, more preferably 80% or more, and even more preferably 85% or more.

The ultraviolet absorption performance can be controlled by adjusting the type, content, and thickness of an ultraviolet absorber.

### <Method for Producing Present Adhesive Sheet>

The present adhesive sheet can be produced by forming a surface layer (β layer) from the β layer-forming resin composition, forming an intermediate layer (α layer) from the α layer-forming resin composition, and laminating the surface layer (β layer) and the intermediate layer (α layer).

The procedures for laminating the intermediate layer (α layer) and the surface layer (β layer) and for curing are not particularly limited. Examples thereof include the following lamination and curing methods.
Method I: Laminating uncured α and β layers, and then curing (primary curing) the α and β layers by light irradiation.
Method II: Laminating a photocured (primary cured) β layer onto an uncured α layer, and then curing (primary curing) the α layer by light irradiation.
Method III: Laminating an uncured β layer onto an α layer cured (primary cured) by light irradiation, and then curing (primary curing) the β layer by light irradiation.
Method IV: Laminating α and β layers that have been separately molded and photocured (primary cured).

Among them, Method I is more preferred from the viewpoint that light irradiation can be performed at once and productivity is better.

The amount of light irradiation (accumulated light amount) for curing (primary curing) the α layer and the β layer by light irradiation is preferably 30 mJ/cm² or more based on a wavelength of 365 nm, more preferably 50 mJ/cm² or more, and even more preferably 100 mJ/cm² or more, from the viewpoint of storage stability at room temperature. In addition, it is preferably 1,000 mJ/cm² or less based on a wavelength of 365 nm, more preferably 500 mJ/cm² or less, and even more preferably 300 mJ/cm² or less, from the viewpoint of step absorbability. Based on a wavelength of 405 nm, it is preferably 20 mJ/cm² or more, more preferably 35 mJ/cm² or more, and even more preferably 70 mJ/cm² or more. In addition, based on a wavelength of 405 nm, it is preferably 700 mJ/cm² or less, more preferably 350 mJ/cm² or less, and even more preferably 210 mJ/cm² or less.

The phrase “based on a wavelength of 365 nm” refers to the measurement results of the accumulated light amount using an accumulated UV meter (UIT-250 and UVD-C365, manufactured by Ushio Inc.), and the phrase “based on a wavelength of 405 nm” refers to the measurement results of the accumulated light amount using an accumulated UV meter (UIT-250 and UVD-C365, manufactured by Ushio Inc.).

Examples of the light source that emits light include high-pressure mercury lamps, metal halide lamps, and LED lamps.

The wavelength of the irradiated light is arbitrary as long as it includes a wavelength that can activate the photopolymerization initiator. The present adhesive sheet may be irradiated with rays, preferably with visible rays, containing substantially no light having a wavelength absorbed by the ultraviolet absorber, for example, a wavelength of less than 380 nm. The phrase “rays containing substantially no light having a wavelength of less than 380 nm” refers to light having a light transmittance of less than 10% at a wavelength of less than 380 nm. As a method of irradiating visible rays not containing light having a wavelength in the ultraviolet region, a light source emitting only visible rays not containing light having a wavelength in the ultraviolet region may be used, or irradiation through a filter that does not transmit light having a wavelength in the ultraviolet region may be used.

### <<Usage Mode of Present Adhesive Sheet>>

The present adhesive sheet can be used alone as it is. It can also be used by being laminated with other members.

### <Present Adhesive Sheet Laminate>

For example, a film such as a mold release film, a protective film, or a film made by laminating them can be laminated on one or both surfaces of the present adhesive sheet to form an adhesive sheet laminate (referred to as the “present adhesive sheet laminate”).

### (Mold Release Film)

In the present adhesive sheet laminate, examples of the mold release film on one or both surfaces include a mold release film having a light transmittance at a wavelength of 410 nm or less of 40% or less. When the mold release film on at least one side has a light transmittance at a wavelength of 410 nm or less of 40% or less, laminating the mold release film onto the present adhesive sheet allows photopolymerization to be effectively prevented from progressing upon irradiation with visible light, even if the present adhesive sheet contains a photopolymerization initiator having an absorption coefficient at a wavelength of 405 nm of 10 mL/(g·cm) or more.

From such a viewpoint, the mold release film on one or both surfaces preferably has a light transmittance at a wavelength of 410 nm or less of 40% or less, more preferably 30% or less, and even more preferably 20% or less.

Examples of the mold release film having a light transmittance at a wavelength of 410 nm or less of 40% or less, i.e., the mold release film that partially blocks the transmission of visible light and ultraviolet light, include one that undergoes a mold release treatment by coating a silicone resin on a cast or stretched film composed of a polyester-based, polypropylene-based, or polyethylene-based resin blended with an ultraviolet absorber.

Examples thereof also include one that undergoes a mold release treatment by coating a silicone resin on one surface of a multilayer cast or stretched film formed by molding a layer composed of a resin containing no ultraviolet absorber on one or both surfaces of a layer composed of a polyester-based, polypropylene-based, or polyethylene-based resin blended with an ultraviolet absorber.

Examples thereof also include one that undergoes a mold release treatment by coating a coating material containing an ultraviolet absorber on one surface of a cast or stretched film composed of a polyester-based, polypropylene-based, or polyethylene-based resin to provide an ultraviolet absorbing layer, and further coating a silicone resin on the ultraviolet absorbing layer.

Examples thereof also include one that undergoes a mold release treatment by coating a coating material containing an ultraviolet absorber on one surface of a cast or stretched film composed of a polyester-based, polypropylene-based, or polyethylene-based resin to provide an ultraviolet absorbing layer, and then coating a silicone resin on another surface of the film.

Examples thereof also include one obtained by laminating the other surface of the mold release treated surface of a resin film composed of a polyester-based, polypropylene-based, or polyethylene-based resin onto a separately prepared resin film that has not been mold release treated, via a bonding layer or an adhesive layer containing an ultraviolet absorber.

The mold release film may have other layers as necessary, such as an antistatic layer, a hardcoat layer, and an anchor layer.

If the thickness of the mold release film is too thick, the cutting processability may be poor, and if the thickness is too thin, the handling performance may be poor and the adhesive sheet may be easily dented. From such a viewpoint, the thickness of the mold release film is preferably 20 μm or more and 300 μm or less, more preferably 25 μm or more or 250 μm or less, and even more preferably 38 μm or more or 200 μm or less.

In the case of a structure in which mold release films are laminated on both surfaces, it is preferred that one mold release film and the other mold release film have different thicknesses and peeling forces.

In the present adhesive sheet laminate, examples of the film on one or both surfaces include films having a light transmittance at a wavelength of 380 nm or more and 410 nm or less of 40% or less, such as a mold release film, a protective film, and a film formed by laminating them. By laminating a film having a light transmittance at a wavelength of 380 nm or more and 410 nm or less of 40% or less on one or both surfaces of the present adhesive sheet, it is possible to prevent the transparent double-sided adhesive sheet from being exposed to light having a wavelength of at least 405 nm, thereby suppressing the generation of radicals by the photopolymerization initiator.

From such a viewpoint, the film on one or both surfaces in the present adhesive sheet laminate preferably has a light transmittance at a wavelength of 380 nm or more and 410 nm or less of 40% or less, more preferably 30% or less, even more preferably 20% or less, and still more preferably 10% or less.

### (Surface Protective Film)

Preferred examples of the structure include one in which a surface protective film having a light transmittance at a wavelength of 410 nm or less of 40% or less is laminated onto one or both surfaces of the present adhesive sheet laminate.

Laminating the surface protective film having a light transmittance at a wavelength of 410 nm or less of 40% or less on at least one surface of the present adhesive sheet laminate allows photopolymerization to be effectively prevented from progressing upon irradiation with visible light, even if the present adhesive sheet contains a photopolymerization initiator having an absorption coefficient at a wavelength of 405 nm of 10 mL/(g·cm) or more.

From such a viewpoint, the surface protective film laminated on one or both surfaces of the present adhesive sheet laminate preferably has a light transmittance at a wavelength of 410 nm or less of 40% or less, more preferably 30% or less, and even more preferably 20% or less.

Examples of the surface protective film having a light transmittance at a wavelength of 410 nm or less of 40% or less, i.e., the surface protective film that partially blocks the transmission of visible light and ultraviolet light, include a laminate film including an ultraviolet absorbing layer obtained by coating a removable slightly adhesive resin on one surface of a polyester-based, polypropylene-based, or polyethylene-based cast or stretched film, and coating a coating material containing an ultraviolet absorber on the other surface.

Examples thereof also include one obtained by coating a removable slightly adhesive resin blended with an ultraviolet absorber on one surface of a polypropylene-based or polyethylene-based cast or stretched film.

Examples thereof also include one obtained by coating a removable slightly adhesive resin on a cast or stretched film composed of a polyester-based, polypropylene-based, or polyethylene-based resin blended with an ultraviolet absorber.

Examples thereof also include one obtained by coating a removable slightly adhesive resin on one surface of a multilayer cast or stretched film formed by molding a layer composed of a resin containing no ultraviolet absorber on one or both surfaces of a layer composed of a polyester-based, polypropylene-based, or polyethylene-based resin blended with an ultraviolet absorber.

Examples thereof also include one obtained by coating a coating material containing an ultraviolet absorber on one surface of a cast or stretched film composed of a polyester-based, polypropylene-based, or polyethylene-based resin to provide an ultraviolet absorbing layer, and further coating a removable slightly adhesive resin on the ultraviolet absorbing layer.

Examples thereof also include one obtained by coating a coating material containing an ultraviolet absorber on one surface of a cast or stretched film composed of a polyester-based, polypropylene-based, or polyethylene-based resin to provide an ultraviolet absorbing layer, and then coating a removable slightly adhesive resin on another surface of the film.

Examples thereof also include one obtained by laminating the other surface of a resin film composed of a polyester-based, polypropylene-based, or polyethylene-based resin coated with a removable slightly adhesive resin onto a separately prepared resin film, via a bonding layer or an adhesive layer containing an ultraviolet absorber.

The surface protective film may have other layers as necessary, such as an antistatic layer, a hardcoat layer, and an anchor layer.

### <Present Image Display Device-Constituting Laminate>

The present adhesive sheet can be used, for example, by being sandwiched and laminated by two image display device-constituting members, and then being irradiated with light for main curing to bond the two image display device-constituting members.

Thus, an image display device-constituting laminate (referred to as the “present image display device-constituting laminate”) having a structure in which two image display device-constituting members are laminated via the present adhesive sheet can be formed.

In this case, the present adhesive sheet may be one that has not yet been photocured, i.e., one having a gel fraction of less than 20% (including 0%), or one that has already been photocured, in which the gel fraction is preferably 20% to 70% as described above.

The present adhesive sheet can then be irradiated with light for main curing to form an image display device-constituting laminate having a structure in which two image display device-constituting members are laminated via the main-cured adhesive sheet obtained by main-curing the present adhesive sheet.

In this case, the gel fraction of the present adhesive sheet after main curing is preferably 40% to 90% as described above.

Examples of the two image display device-constituting members include any one or a combination of two or more types selected from the group consisting of a touch sensor, an image display panel, a surface protective panel, and a polarizing film.

Specific examples of the structure of the present image display device-constituting laminate include structures composed of: mold release sheet/present adhesive sheet/touch panel; mold release sheet/present adhesive sheet/protective panel; mold release film/present adhesive sheet/image display panel; image display panel/present adhesive sheet/touch panel; image display panel/the present adhesive sheet/protective panel; image display panel/present adhesive sheet/touch panel/present adhesive sheet/protective panel; polarizing film/present adhesive sheet/touch panel; and polarizing film/present adhesive sheet/touch panel/present adhesive sheet/protective panel. However, it is not limited to these laminate examples.

The touch panel includes a structure in which the touch panel functions are incorporated in a protective panel, or a structure in which the touch panel functions are incorporated in an image display panel.

In the present image display device-constituting laminate, at least one of the two image display device-constituting members may have ultraviolet absorption performance, for example, may contain an ultraviolet absorber.

Since the present adhesive sheet is cured by light in a wavelength region other than ultraviolet rays, such as visible light, but not by ultraviolet rays, the surface layer (β layer) and the intermediate layer (α layer) of the present adhesive sheet can be cured by irradiation with visible light through the image display device-constituting member even if the image display device-constituting member has ultraviolet absorption performance.

### (Method for Producing Present Image Display Device-Constituting Laminate)

The present adhesive sheet has an ultraviolet absorption function and curability that enables curing by irradiation with light having a wavelength other than the ultraviolet region, especially visible light. Utilizing such characteristics of the present adhesive sheet, the present image display device-constituting laminate can be produced by, for example, the following method.

The present image display device-constituting laminate can be produced by forming the present adhesive sheet (sheet producing step), and then laminating two image display device-constituting members via the present adhesive sheet (bonding step), thereby producing an image display device-constituting laminate having a structure in which the present adhesive sheet is placed between the two image display device-constituting members.

### [Sheet Producing Step]

Examples of the method for producing the present adhesive sheet include film-forming the adhesive sheet into a sheet shape on the mold release film, followed by curing to produce the present adhesive sheet.

Alternatively, by film-forming the adhesive sheet into a sheet shape on an image display device-constituting member, followed by curing, the present adhesive sheet may be laminated on the image display device-constituting member.

### [Bonding Step]

The present adhesive sheet can be bonded by simply overlapping two image display device-constituting members via the present adhesive sheet due to the adhesive property of the surface layer (β layer).

Examples of the two image display device-constituting members include any one or a combination of two or more types selected from the group consisting of a touch sensor, an image display panel, a surface protective panel, and a polarizing film.

Specific examples of the structure of the image display device-constituting laminate include structures composed of: mold release sheet/present adhesive sheet/touch panel; mold release sheet/present adhesive sheet/protective panel; mold release sheet/present adhesive sheet/liquid crystal panel; liquid crystal panel/present adhesive sheet/touch panel; liquid crystal panel/present adhesive sheet/protective panel; liquid crystal panel/present adhesive sheet/touch panel/present adhesive sheet/protective panel; polarizing film/present adhesive sheet/touch panel; and polarizing film/present adhesive sheet/touch panel/present adhesive sheet/protective panel. However, it is not limited to these laminate examples.

A known bonding device can be used for lamination. Examples thereof include an electric heat press machine equipped with a heating plate, a diaphragm type laminator, a roll laminator, a vacuum bonding machine, and a hand roller.

### <Present Image Display Device>

The present adhesive sheet or the present image display device-constituting laminate as described above can be used to produce an image display device (referred to as the “present image display device”).

The produced present image display device may be one including an image display device-constituting laminate having a structure laminated via an adhesive sheet after main curing obtained by main-curing the present adhesive sheet.

Examples of the present image display device constituted include image display devices such as a liquid crystal display, an organic electroluminescent (EL) display, an inorganic EL display, an electronic paper, a plasma display, and a micro electromechanical system (MEMS) display.

In the present image display device, at least one of the image display device-constituting members constituting the image display device may have ultraviolet absorption performance, for example, may contain an ultraviolet absorber.

Since the present adhesive sheet is cured by visible light, but not by ultraviolet rays, the surface layer (β layer) and the intermediate layer (α layer) of the present adhesive sheet can be cured by irradiation with visible light through the image display device-constituting member even if the image display device-constituting member has ultraviolet absorption performance.

### Explanation of Terms and Phrases

Herein, the term “sheet” generally means a thin and flat product that has a small thickness relative to its length and width according to the definition of Japanese Industrial Standards (JIS), and the term “film” generally means a thin and flat product that has an extremely small thickness relative to its length and width, in which the maximum thickness is arbitrarily limited, and that is usually supplied in the form of roll (Japanese Industrial Standards JIS K6900). However, there is no definite boundary between the sheet and the film, and there is no need of literally distinguishing these terms. In the present invention, accordingly, the case referred to as a “film” is assumed to include a “sheet”, and the case referred to as a “sheet” is assumed to include a “film”.

In addition, in the case of being expressed as “panel” such as an image display panel and a protective panel, it is intended to include a plate body, a sheet, and a film.

In the case of being described as the phrase “X to Y” (X and Y represent arbitrary numbers) in the present specification, the phrase includes the meaning of “preferably more than X” or “preferably less than Y” along with the meaning “X or more and Y or less”, unless otherwise stated.

Also, the phrase “X or more” (X represents an arbitrary number) or “Y or less” (Y represents an arbitrary number) includes the meaning “preferably more than X” or “preferably less than Y”, unless otherwise stated.

Further, the term “or” means “and/or”.

### EXAMPLES

The present invention is hereunder described in more detail with reference to Examples. The present invention is not limited to the following Examples as long as not exceeding the gist of the present invention.

In Examples, the term “part” means a value based on mass.

### <(Meth)Acrylic Polymer>

(Meth)Acrylic Polymer (A-1):

Acrylic polymer (mass average molecular weight of 300,000 and glass transition temperature of −45° C.) obtained by copolymerizing: 6 parts by mass of a polymethyl methacrylate macromonomer (glass transition temperature of 105° C.) having a number average molecular weight of 2,400; 90 parts by mass of butyl acrylate (glass transition temperature of −55° C.); and 4 parts by mass of acrylic acid (glass transition temperature of 106° C.)
(Meth)Acrylic Polymer (A-2):

Acrylic polymer (mass average molecular weight of 260,000 and glass transition temperature of 8° C.) obtained by copolymerizing: 13.5 parts by mass of a macromonomer composed of isobornyl methacrylate and methyl methacrylate (1:1), having a terminal functional group of methacryloyl group and a number average molecular weight of 3,000; 73.7 parts by mass of 2-ethylhexyl acrylate (glass transition temperature of −70° C.); 10 parts by mass of methyl acrylate (glass transition temperature of 8° C.); and 2.8 parts by mass of acrylamide (glass transition temperature of 165° C.)

The glass transition temperature of each copolymerized component in the (meth)acrylic polymers is a literature value of the glass transition temperature obtained from the homopolymer of each component. As for the macromonomers, the glass transition temperature is described as a literature value of the glass transition temperature obtained from the homopolymer of the component forming a high molecular weight skeleton in each of the macromonomers.

The glass transition temperature of each (meth)acrylic polymer is a value calculated from the glass transition temperature and composition ratio of each copolymerized component using Fox's calculation formula.

### <Crosslinking Agent>

Crosslinking Agent (B-1):

Pentaerythritol triacrylate (“A-TMM-3L”, manufactured by Shin-Nakamura Chemical Co., Ltd.)
Crosslinking Agent (B-2):

Pentaerythritol triacrylate (“Aronix M-933”, manufactured by Toagosei Co., Ltd.)
Crosslinking Agent (B-3):

Propylene oxide-modified pentaerythritol tri (tetra) acrylate (“ATM-4PL”, manufactured by Shin-Nakamura Chemical Co., Ltd.)

The crosslinking agents (B-1) and (B-2) are both pentaerythritol triacrylates, but have slightly different properties due to differences in the amount of impurities such as those with less than five erythritol groups and less than three acrylate groups.

### <Photopolymerization Initiator>

Photopolymerization Initiator (C-1): Cleavage-Type Photopolymerization Initiator:

Ethyl phenyl(2,4,6-trimethylbenzoyl)phosphinate (“Omnirad TPO-L”, manufactured by IGM)
Photopolymerization Initiator (C-2): Hydrogen Abstraction-Type Photopolymerization Initiator:

A mixture of 2,4,6-trimethylbenzophenone and 4-methylbenzophenone (“Esacure TZT”, manufactured by IGM)
Photopolymerization Initiator (C-3): Mixture of 96% by mass of Cleavage-Type and 4% by mass of Hydrogen Abstraction-Type:

A mixture of 2,4,6-(trimethylbenzoyl) phosphine oxide (cleavage-type, “Omnirad TPO”, manufactured by IGM, 46% by mass), 2-hydroxy-1-(4-isopropenylphenyl)-2-methylpropane-1-on (cleavage-type, “Esacure KIP150”, manufactured by IGM, 50% by mass), and 4% by mass of TZT (C-2) (“Esacure KTO46”, manufactured by IGM)

The photopolymerization initiators (C-1) and (C-3) are photopolymerization initiators that can be activated by light having a wavelength of 405 nm or more, while the photopolymerization initiator (C-2) is not a photopolymerization initiator that can be activated by light having a wavelength of 405 nm or more.

### <Ultraviolet Absorber>

Ultraviolet Absorber (D-1):

2-[4,6-bis(2,4-dimethylphenyl)-1,3,5-triazine-2-yl]-5-[3-(2-ethylhexyloxy)-2-hydroxypropoxy] phenol (“Tinuvin 405”, manufactured by BASF)
Ultraviolet Absorber (D-2):

2,2-Dimethyl-4-methoxybenzophenone (“KEMISORB 111”, manufactured by Chemipro Kasei Kaisha, Ltd.)

### <Silane Coupling Agent>

3-Glycidyloxypropyltrimethoxysilane (“KBM403”, manufactured by Shin-Etsu Chemical Co., Ltd.)

### <Rust Inhibitor>

1, 2, 3-Triazole (“1,2,3-triazole”, manufactured by Otsuka Chemical Co., Ltd.)

### Example 1

A resin composition forming an intermediate layer (α layer) was prepared by mixing 100 parts by mass of the (meth)acrylic polymer (A-1), 8 parts by mass of the crosslinking agent (B-1), and 0.5 part by mass of the photopolymerization initiator (C-1).

An adhesive composition forming a surface layer (β layer) was prepared by mixing 100 parts by mass of the (meth)acrylic polymer (A-2), 8 parts by mass of the crosslinking agent (B-2), 0.5 part by mass of the photopolymerization initiator (C-1), 0.5 part by mass of the ultraviolet absorber (D-1), 0.2 part by mass of the silane coupling agent, and 0.3 part by mass of the rust inhibitor.

The resin composition forming an intermediate layer (a layer) and the adhesive composition forming a surface layer (β layer) were each supplied to two separate extruders and co-extruded to obtain an adhesive sheet 1′ having a layer structure of two types and three layers (surface layer (B layer)/intermediate layer (α layer)/surface layer (β layer), with a thickness ratio of 1:3:1 (total thickness of 250 μm)).

Next, the adhesive sheet 1′ was sandwiched between two mold release films, which were two polyethylene terephthalate films whose surfaces were mold release treated (“DIAFOIL MRV (V06)” with a thickness of 100 μm and “DIAFOIL MRQ” with a thickness of 75 μm, both manufactured by Mitsubishi Chemical Corp.), and hot-melt molded into a sheet shape with a thickness of 250 μm, thereby obtaining an adhesive sheet laminate having a structure of mold release film/adhesive sheet 1′/mold release film.

The adhesive sheet laminate was irradiated with light from both sides using a high-pressure mercury lamp to be slightly cured, thereby producing an adhesive sheet 1.

The light irradiation described above was performed using an accumulated UV meter (UIT-250 and UVD-C365, manufactured by Ushio Inc.) at an irradiation amount such that the accumulated light amount based on a wavelength of 365 nm was 200 mJ/cm² (the accumulated light amount based on a wavelength of 405 nm measured using an accumulated UV meter (UIT-250 and UVD-C405, manufactured by Ushio Inc.) was 140 mJ/cm²). The accumulated light amount received by the adhesive sheet was 150 mJ/cm².

The adhesive sheet 1 obtained as described above is in the state of temporary curing (primary curing), and is an adhesive sheet having photocurability that enables main curing (secondary curing) by irradiation with light.

### Examples 2 and 3 and Comparative Examples 1 and 2

Adhesive sheets 2 to 5 were produced in the same manner as in Example 1, except that the composition of each layer and the amount of light irradiation were changed as shown in Table 1.

Each of the adhesive sheets obtained as described above is in the state of temporary curing (primary curing), and is an adhesive sheet having photocurability that enables main curing (secondary curing) by irradiation with light.

### Comparative Example 3

The evaluations were performed in the same manner as in Example 1, except that the adhesive sheet used was a commercially available non-curable acrylic transparent adhesive sheet for optical use (adhesive sheet 6) having no photocurability.

### [Physical Property Measurements and Evaluations]

The adhesive sheets 1 to 6 prepared in Examples and Comparative Examples were subjected to the following various measurements and evaluations. The evaluation results are summarized in Table 1.

### <Gel Fraction>

The mold release films on both sides of the adhesive sheet laminate produced in each of Examples and Comparative Examples were peeled off, the adhesive sheet was wrapped in a bag made of SUS mesh (#200) whose mass (M) was measured in advance, the opening of the bag was folded closed, the mass (M1) of the bag was measured, and the bag was then immersed in 100 mL of ethyl acetate and stored in a dark place at 23° C. for 24 hours. The bag was then taken out and heated at 70° C. for 4.5 hours to evaporate the adhering ethyl acetate, and the mass (M2) of the dried bag was measured. The obtained masses were substituted in the following formula to obtain a gel fraction G1 of the adhesive sheet (before curing: after primary curing).

Gel fraction G1(%)=[(M2−M)/(M1−M)]×100

For the gel fraction of the adhesive sheet after photocuring, the adhesive sheet laminate produced in each of Examples and Comparative Examples was irradiated with light (main curing (secondary curing)) using a high-pressure mercury lamp such that the accumulated light amount based on a wavelength of 365 nm was 3,000 mJ/cm² (2,000 mJ/cm² based on a wavelength of 405 nm). Thereafter, the mold release films on both sides were peeled off, the adhesive sheet was wrapped in a bag made of SUS mesh (#200) whose mass (M4) was measured in advance, the opening of the bag was folded closed, the mass (M5) of the bag was measured, and the bag was then immersed in 100 mL of ethyl acetate and stored in a dark place at 23° C. for 24 hours. The bag was then taken out and heated at 70° C. for 4.5 hours to evaporate the adhering ethyl acetate, and the mass (M6) of the dried bag was measured. The obtained masses were substituted in the following formula to obtain a gel fraction G2 of the adhesive sheet (after curing: after main curing (secondary curing)).

Gel fraction G2(%)=[(M6−M4)/(M5−M4)]×100

As for the light irradiation of the accumulated light amount of 3,000 mJ/cm², the light irradiation was performed using an accumulated UV meter (UIT-250 and UVD-C365, manufactured by Ushio Inc.) such that the accumulated light amount based on a wavelength of 365 nm was 3,000 mJ/cm². The accumulated light amount based on a wavelength of 405 nm measured using an accumulated UV meter (UIT-250 and UVD-C405, manufactured by Ushio Inc.) was 2,000 mJ/cm².

### <Spectral Characteristics: Light Transmittance>

The mold release films on both sides of the adhesive sheet laminate produced in each of Examples and Comparative Examples were peeled off, and the spectral transmittance (% T) of each adhesive sheet was measured at a wavelength of 300 to 800 nm using a spectrophotometer (UV2000, manufactured by Shimadzu Corp.).

### <Stress Relaxation Rate>

### (Before Main Curing (Before Secondary Curing))

The mold release films on both sides of the adhesive sheet laminate produced in each of Examples and Comparative Examples were peeled off, and multiple sheets of the adhesive sheet were laminated to prepare a sheet having a thickness of 0.8 to 1.2 mm (approximately 0.8 mm). The sheet was punched out into a circle shape having a diameter of 8 mm to prepare a sample; the sample was subjected to a measurement after applying 25% strain to the sample by shearing under the conditions where the adhesive jig was @8 mm parallel plate and the measurement environment was 25° C. by using a rheometer (DHR-2, manufactured by TA Instruments Japan Inc.); the stress value measured after the elapse of 10 seconds was measured as the stress value (X) and the stress value measured after the elapse of 300 seconds was measured as the stress value (Y); and the stress relaxation rate was calculated by the following formula.

Stress relaxation rate (%)={(X−Y)/X}×100

### (After Main Curing (After Secondary Curing))

For the stress relaxation rate of the adhesive sheet after photocuring (after main curing, i.e., after secondary curing), the adhesive sheet laminate produced in each of Examples and Comparative Examples was irradiated with light (main curing, i.e., secondary curing) using a high-pressure mercury lamp such that the accumulated light amount based on a wavelength of 365 nm was 3,000 mJ/cm² (2,000 mJ/cm² based on a wavelength of 405 nm); the mold release films on both sides were then peeled off; multiple sheets of the adhesive sheet were laminated to prepare a sheet having a thickness of 0.8 to 1.2 mm (approximately 0.8 mm); and the stress relaxation rate was calculated in the same manner as above.

### <Ultraviolet Resistance Evaluation>

### (Chromaticity Evaluation)

The mold release film on one surface of the adhesive sheet laminate produced in each of Examples and Comparative Examples was peeled off, and the exposed adhesive surface was bonded to soda lime glass (160 mm×68 mm×0.55 mm thick) using a hand roller. The remaining mold release film was then peeled off; the exposed adhesive surface was bonded to soda lime glass (160 mm×68 mm×0.55 mm thick) using a hand roller; and the laminate was irradiated with light (main curing (secondary curing)) using a high-pressure mercury lamp such that the accumulated light amount based on a wavelength of 365 nm was 3,000 mJ/cm² (2,000 mJ/cm² based on a wavelength of 405 nm) to prepare an evaluation sample.

The resulting evaluation sample was mounted on a Super Xenon Weather Meter (“SX75”, manufactured by Suga Test Instruments Co., Ltd.), and the apparatus was operated for 360 hours at an illuminance of 120 W/m², a black panel temperature of 105° C., a chamber temperature of 90° C., and a chamber humidity of 55%. The b-value of the evaluation sample after the elapse of 360 hours was measured and evaluated according to the following criteria.
⊚ (very good) . . . less than 2.5
◯ (good) . . . 2.5 or more and less than 4.5
x (poor) . . . 4.5 or more

### (Foaming Evaluation)

An evaluation sample was prepared in the same manner as the evaluation sample prepared in the chromaticity evaluation.

The resulting evaluation sample was mounted on a Super Xenon Weather Meter (“SX75”, manufactured by Suga Test Instruments Co., Ltd.), and the apparatus was operated for 360 hours at an illuminance of 120 W/m², a black panel temperature of 105° C., a chamber temperature of 90° C., and a chamber humidity of 55%. The evaluation sample after the elapse of 360 hours was observed for the presence or absence of foaming.
◯ (good) . . . No foaming
x (poor) . . . With foaming

### <Step Absorbability>

The mold release film on one surface of the adhesive sheet laminate produced in each of Examples and Comparative Examples was peeled off, and the exposed adhesive surface was bonded to soda lime glass (78 mm×50 mm×0.55 mm thick) having ink steps of 15 to 20 μm on four sides by reciprocating a hand roller once. The remaining mold release film was then peeled off, and the exposed adhesive surface was press-bonded on soda lime glass (75 mm×160 mm×0.55 mm thick) having no ink steps under reduced pressure (absolute pressure of 2 kPa) using a vacuum bonding machine. Subsequently, the laminate was subjected to an autoclave treatment (60° C., gauge pressure of 0.3 MPa, 20 minutes) for final pressure bonding, observed for the presence or absence of air bubbles, and then evaluated according to the following criteria.
◯ (good) . . . No bubbles generated in steps of 15 to 20 μm
x (poor) . . . Bubbles generated in steps of 15 to 20 μm

TABLE 1

| | | | Example 1 | | | Example 2 | | | Example 3 | | |
|---|---|---|---|---|---|---|---|---|---|---|---|
| | | | Adhesive sheet 1 | | | Adhesive sheet 2 | | | Adhesive sheet 3 | | |
| | | | Outer | Inter- | Back | Outer | Inter- | Back | Outer | Inter- | Back |
| | | | most | mediate | most | most | mediate | most | most | mediate | most |
| | | | layer | layer | layer | layer | layer | layer | layer | layer | layer |
| Resin | (Meth)acrylic copolymer | A-1 | — | 100 | — | 100 | 100 | 100 | — | 100 | — |
| composition | | A-2 | 100 | — | 100 | — | — | — | 100 | — | 100 |
| (parts by | Crosslinking agent | B-1 | — | 8 | — | — | 5 | — | — | 8 | — |
| mass) | | B-2 | 8 | — | 8 | 5 | — | 5 | — | — | — |
| | | B-3 | — | — | — | — | — | — | 8 | — | 8 |
| | Photopolymerization | C-1 | 0.5 | 0.5 | 0.5 | 0.5 | 0.5 | 0.5 | 0.5 | 0.5 | 0.5 |
| | initiator | C-2 | — | — | — | — | — | — | — | — | — |
| | | C-3 | — | — | — | — | — | — | — | — | — |
| | Ultraviolet absorber | D-1 | 0.5 | — | 0.5 | 0.5 | — | 0.5 | 1 | — | 1 |
| | | D-2 | — | — | — | — | — | — | — | — | — |
| | Silane coupling agent | | 0.2 | — | 0.2 | 0.2 | — | 0.2 | 0.2 | — | 0.2 |
| | Rust inhibitor | | 0.3 | — | 0.3 | 0.3 | — | 0.3 | 0.3 | — | 0.3 |

| | | | | | | | |
|---|---|---|---|---|---|---|---|
| Light | Irradiation amount in primary curing | 150 | mJ/cm² | 150 | mJ/cm² | 150 | mJ/cm² |

| | |
|---|---|
| irradiation | (cumulative light amount) |

| | | | | | | |
|---|---|---|---|---|---|---|
| Irradiation amount in secondary curing | 3000 | mJ/cm² | 3000 | mJ/cm² | 3000 | mJ/cm² |

| | (cumulative light amount) | | | | |
|---|---|---|---|---|---|
| Physical | Gel | G1 (before curing: after | 50 | 43 | 49 |
| properties | fraction (%) | primary curing) | | | |

| | | | | |
|---|---|---|---|---|
| evaluation | G2 (after curing: after | 62 | 54 | 61 |

secondary curing)

| | | | | |
|---|---|---|---|---|
| Spectral | Wavelength 320 nm | 1 | 1 | 1 |
| characteristics | Wavelength 340 nm | 1 | 1 | 2 |
| (% T) | Wavelength 385 nm | 34 | 33 | 37 |
| UV 4J | Wavelength 380 nm | 75 | 74 | 78 |
| | Wavelength 395 nm | 88 | 85 | 88 |
| Before | Stress value (X) (Pa) | 31759 | 19593 | 30683 |
| secondary | Stress value (Y) (Pa) | 12146 | 10086 | 11610 |
| curing | Stress relaxation rate (% [symbol] | 62 | 49 | 62 |
| After | Stress value (X) (Pa) | 38271 | 15310 | 25263 |
| secondary | Stress value (Y) (Pa) | 19952 | 7962 | 12918 |
| curing | Stress relaxation rate (% [symbol] | 48 | 48 | 49 |

| | | | |
|---|---|---|---|
| Ultraviolet resistance (chromaticity) | ⊚ | ⊚ | ⊚ |
| Ultraviolet resistance (foaming) | ◯ | ◯ | ◯ |
| Step absorbability | ◯ | ◯ | ◯ |

| Comparative Example 1 | | | Comparative Example 2 | | | Comparative |
|---|---|---|---|---|---|---|
| Adhesive sheet 4 | | | Adhesive sheet 5 | | | Example 3 |
| Outer | Inter- | Back | Outer | Inter- | Back | Adhesive |
| most | mediate | most | most | mediate | most | sheet 6 |
| layer | layer | layer | layer | layer | layer | Single layer |

| | | | | | | | | |
|---|---|---|---|---|---|---|---|---|
| Resin | (Meth)acrylic copolymer | A-1 | 100 | 100 | 100 | 100 | 100 | 100 |
| composition | | A-2 | — | — | — | — | — | — |
| (parts by | Crosslinking agent | B-1 | — | 8 | — | 3 | 6 | 3 |
| mass) | | B-2 | 8 | — | 8 | — | — | — |
| | | B-3 | — | — | — | — | — | — |
| | Photopolymerization | C-1 | — | — | — | — | 0.5 | — |
| | initiator | C-2 | 0.5 | 0.5 | 0.5 | — | — | — |
| | | C-3 | — | — | — | 1 | — | 1 |
| | Ultraviolet absorber | D-1 | 0.5 | — | 0.5 | — | — | — |
| | | D-2 | — | — | — | — | 0.5 | — |
| | Silane coupling agent | | 0.2 | — | 0.2 | 0.2 | — | 0.2 |
| | Rust inhibitor | | 0.3 | — | 0.3 | 0.3 | — | 0.3 |

| | | | | | |
|---|---|---|---|---|---|
| Light | Irradiation amount in primary curing | 150 | mJ/cm² | 29 | mJ/cm² |

| | |
|---|---|
| irradiation | (cumulative light amount) |

| | | | | |
|---|---|---|---|---|
| Irradiation amount in secondary curing | 3000 | mJ/cm² | 3000 | mJ/cm² |

| | (cumulative light amount) | | | | |
|---|---|---|---|---|---|
| Physical | Gel | G1 (before curing: after | 1 | 13 | 71 |
| properties | fraction (%) | primary curing) | | | |

| | | | | |
|---|---|---|---|---|
| evaluation | G2 (after curing: after | 38 | 39 | — |

secondary curing)

| | | | | |
|---|---|---|---|---|
| Spectral | Wavelength 320 nm | less than 1 | 0 | 26 |
| characteristics | Wavelength 340 nm | 1 | 0 | 59 |
| (% T) | Wavelength 385 nm | 28 | 0 | 77 |
| UV 4J | Wavelength 380 nm | 73 | 2 | 83 |
| | Wavelength 395 nm | 85 | 31 | 87 |
| Before | Stress value (X) (Pa) | 8525 | 5605 | 18028 |
| secondary | Stress value (Y) (Pa) | 3544 | 1696 | 13224 |
| curing | Stress relaxation rate (% [symbol] | 58 | 70 | 27 |
| After | Stress value (X) (Pa) | 12833 | 14422 | — |
| secondary | Stress value (Y) (Pa) | 6892 | 6799 | |
| curing | Stress relaxation rate (% [symbol] | 46 | 53 | |

| | | | |
|---|---|---|---|
| Ultraviolet resistance (chromaticity) | X | ⊚ | — |
| Ultraviolet resistance (foaming) | ◯ | X | ◯ |
| Step absorbability | ◯ | ◯ | X |

[symbol]

indicates data missing or illegible when filed

### DISCUSSION

It was observed that the adhesive sheets obtained in Examples 1 to 3 all effectively prevented ultraviolet degradation in terms of both chromaticity and foaming, and also had excellent step absorbability.

On the other hand, it was observed that the adhesive sheet obtained in Comparative Example 1, since it did not use a photopolymerization initiator capable of being activated by light having a wavelength of 405 nm or more, exhibited chromaticity degradation due to ultraviolet rays.

It was also observed that the adhesive sheet obtained in Comparative Example 2, since it did not contain an ultraviolet absorber in the surface layer, caused foaming due to ultraviolet rays.

Based on the results of the above Examples and Comparative Examples and the tests conducted to date by the present inventors, it is found that when, in a double-sided adhesive sheet having a laminate structure with an intermediate layer (α layer) and a surface layer (β layer), the intermediate layer (α layer) is formed from a resin composition containing a (meth)acrylic polymer, a crosslinking agent, and a photopolymerization initiator, and the surface layer (β layer) is formed from an adhesive composition containing a (meth)acrylic polymer, a crosslinking agent, a photopolymerization initiator that can be activated by light having a wavelength of 405 nm or more, and an ultraviolet absorber, the actions by the ultraviolet absorber contained in the surface layer (β layer) prevent ultraviolet degradation not only of the image display members but also of the adhesive sheet itself, i.e., both the intermediate layer (α layer) and the surface layer (β layer), and thus provide excellent discoloration resistance. It is also found that the present adhesive sheet has a predetermined stress relaxation rate and has excellent step absorbability.

In the above Examples, the copolymers containing a structural unit derived from a macromonomer are exemplified as (meth)acrylic polymers. However, even if other (meth)acrylic polymers are used, the mechanism of photocuring actions may be the same, and therefore, based on common technical knowledge, it can be assumed that the same effects as in the above Examples can be obtained even when other (meth)acrylic polymers are used.

### INDUSTRIAL APPLICABILITY

The double-sided adhesive sheet according to the present invention can be suitably used for in-vehicle image display device-constituting members, since it prevents optical members present in the deep layer, i.e., adherends such as image display device-constituting members, from being degraded by ultraviolet rays, and has excellent discoloration resistance and step absorbability.

1. A double-sided adhesive sheet having a laminate structure comprising α layer and β layer, the β layer being a surface layer,
wherein the α layer is formed from a resin composition containing a (meth)acrylic polymer, a crosslinking agent, and a photopolymerization initiator;
the β layer is formed from an adhesive composition containing a (meth)acrylic polymer, a crosslinking agent, a photopolymerization initiator that can be activated by light having a wavelength of 405 nm or more, and an ultraviolet absorber; and
the double-sided adhesive sheet has a stress relaxation rate of 30% or more as calculated below,
wherein the stress relaxation rate is obtained by applying 25% strain to the double-sided adhesive sheet having a thickness in a range of 0.8 to 1.2 mm and a circle shape with a diameter of 8 mm in an environment of 25° C., measuring a stress value (X) after the elapse of 10 seconds and a stress value (Y) after the elapse of 300 seconds, and calculating with the following formula:
stress relaxation rate (%)={(X−Y)/X}×100.

2. The double-sided adhesive sheet according to claim 1, wherein the stress value (X) is 5,000 to 500,000 Pa and the stress value (Y) is 5,000 to 300,000 Pa.

3. The double-sided adhesive sheet according to claim 1, wherein the photopolymerization initiator contained in the β layer comprises a cleavage-type photopolymerization initiator.

4. The double-sided adhesive sheet according to claim 1, wherein the α layer comprises a cleavage-type photopolymerization initiator that can be activated by light having a wavelength outside the ultraviolet region.

5. The double-sided adhesive sheet according to claim 1, wherein the photopolymerization initiator comprises an acylphosphine oxide-based cleavage-type photopolymerization initiator.

6. The double-sided adhesive sheet according to claim 1, wherein the double-sided adhesive sheet has a light transmittance at a wavelength of 365 nm or less of 50% or less.

7. The double-sided adhesive sheet according to claim 1, wherein the α layer and the β layer each comprise substantially no thermal polymerization initiator.

8. The double-sided adhesive sheet according to claim 1, wherein the α layer has a concentration of the ultraviolet absorber lower than that of the ultraviolet absorber in the β layer.

9. The double-sided adhesive sheet according to claim 1, wherein the adhesive compositions forming the α layer and the β layer are different adhesive compositions from each other.

10. The double-sided adhesive sheet according to claim 1, wherein the (meth)acrylic polymer comprises a copolymer containing a structural unit derived from a macromonomer.

11. The double-sided adhesive sheet according to claim 1, wherein the double-sided adhesive sheet has a gel fraction of 20% to 70%.

12. The double-sided adhesive sheet according to claim 1, wherein the double-sided adhesive sheet is sandwiched and laminated by two image display device-constituting members, and then cured by irradiation with light to bond the two image display device-constituting members.

13. The double-sided adhesive sheet according to claim 1, wherein the double-sided adhesive sheet has photocurability.

14. The double-sided adhesive sheet according to claim 1, wherein the double-sided adhesive sheet is cured by irradiation with light.

15. An image display device-constituting laminate having a structure in which two image display device-constituting members are laminated via the double-sided adhesive sheet according to claim 1.

16. An image display device-constituting laminate having a structure in which two image display device-constituting members are laminated via a cured adhesive sheet obtained by curing the double-sided adhesive sheet according to claim 1.

17. The image display device-constituting laminate according to claim 16, wherein the cured adhesive sheet has a gel fraction of 40% to 90%.

18. An image display device comprising the image display device-constituting laminate according to claim 15.

19. The double-sided adhesive sheet according to claim 1, the α layer is an intermediate layer.

20. The double-sided adhesive sheet according to claim 1, further comprise a second surface layer.
